(19) United States
(12) Patent Application Publication
(10) Pub. No.: US 2018/0026364 A1
(43) Pub. Date: Jan. 25, 2018

(54) COMMUNICATION DEVICE

(71) Applicant: JIENG TAI INTERNATIONAL ELECTRIC CORP., New Taipei City (TW)

(72) Inventor: Yu-Pang CHOU, New Taipei City (TW)

(21) Appl. No.: 15/356,650

(22) Filed: Nov. 20, 2016

(30) Foreign Application Priority Data
Jul. 20, 2016 (TW) 105122887

(51) Int. Cl. H01Q 3/24; H01Q 1/24

(52) U.S. Cl. CPC H01Q 3/24; H01Q 1/24

(57) ABSTRACT

A communication device includes a first sensing electrode, a sensing and processing unit, a radio frequency unit, a first antenna and a second antenna. The radio frequency unit, the first antenna and the second antenna are coupled to the sensing and processing unit. The radio frequency unit is configured to generate a radio frequency signal. The first sensing electrode is configured to sense a first capacitance when an object approaches the communication device. The sensing and processing unit is configured to generate a relative position signal of the object and the communication device according to the first capacitance. The sensing and processing unit is further configured to control one of the first antenna and the second antenna to send the radio frequency signal according to the relative position signal.

### RELATED APPLICATIONS

This application claims priority to Taiwan Application Serial Number 105122887, filed Jul. 20, 2016, which is herein incorporated by reference.

### BACKGROUND

### Technical Field

The present invention relates to a communication device. More particularly, the present invention relates to a communication device for determining a relative position from an approaching object.

### Description of Related Art

A communication device can transmit or receive radio waves through an antenna for delivering or exchanging radio signals. However, the efficiency of radio signals is easily affected by the environment (such as a human body or another electronic device). Using a portable electronic device (such as a cell phone) as an example for explanation, when a user uses the portable electronic device, the efficiency of an antenna in the portable electronic device is sometimes decreased for particular application due to different hand gestures when a user uses the portable electronic device. Therefore, people in the related art have urgency to solve the problem of detecting different hand gestures.

### SUMMARY

An aspect of the present disclosure is to provide a communication device. The communication device includes a first sensing electrode, a sensing and processing unit, a radio frequency unit, a first antenna and a second antenna. The radio frequency unit, the first antenna and the second antenna is coupled to the sensing and processing unit. The radio frequency unit is configured to generate a radio frequency signal. The first sensing electrode is configured to sense a first capacitance when an object approaches the communication device. The sensing and processing unit is configured to generate a relative position signal of the object and the communication device according to the first capacitance. The sensing and processing unit is further configured to control one of the first antenna and the second antenna to send the radio frequency signal according to the relative position signal.

In conclusion, the communication device of the present disclosure can determine the relative position of the object and the communication device through the sensing electrode, improve the antenna performance and display the user interface that is convenient for operation according to the relative position. Moreover, the present disclosure can also measure the current physical parameter of the user.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a communication device according to an embodiment of the present disclosure;

FIG. 2 is a schematic diagram of a communication device according to an embodiment of the present disclosure;

FIG. 3 is a schematic diagram of a communication device according to an embodiment of the present disclosure;

FIG. 4 is a schematic diagram of a communication device according to an embodiment of the present disclosure;

FIG. 5 is a schematic diagram of a count signal and a position signal relative position signal of the present disclosure;

FIG. 6 is a schematic diagram of a user interface according to an embodiment of the present disclosure;

FIG. 7 is a schematic diagram of a user interface according to an embodiment of the present disclosure; and

FIG. 8 is a schematic diagram of a sensing and processing unit according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

In this document, the term “coupled” may also be termed as “electrically coupled,” and the term “connected” may be termed as “electrically connected.” “Coupled” and “connected” may also be used to indicate that two or more elements cooperate or interact with each other.

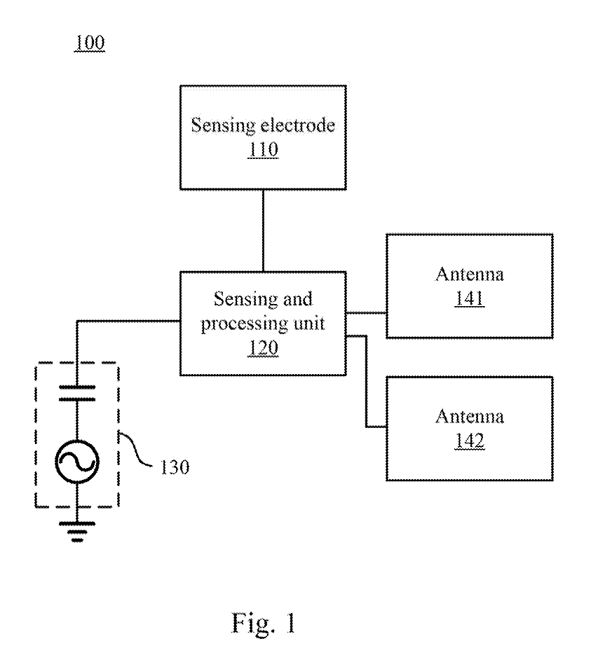

Reference is made to FIG. 1. FIG. 1 is a schematic diagram of a communication device 100 according to an embodiment of the present disclosure. The communication device 100 may be any electronic product with a communication function, such as a cell phone, a tablet PC (Tablet personal computer), a wireless access point device, etc. As shown in FIG. 1, in the present embodiment, the communication device 100 includes a sensing electrode 110, a sensing and processing unit 120, a radio frequency unit 130, an antenna 141 and an antenna 142. The radio frequency unit 130, the antenna 141 and the antenna 142 are coupled to the sensing and processing unit 120. The sensing electrode 110 is configured to sense a first capacitance C1 when an object (e.g., a human body) approaches the communication device 100. For example, the sensing electrode 110 has an original capacitance, generates an additional parasitic capacitance when the object approaches the sensing electrode 110, and the sensing electrode 110 has the first capacitance C1 at the moment.

The sensing and processing unit 120 is configured to generate a relative position signal of the object and the communication device 100 according to the first capacitance C1. Specifically, as the object is closer to the sensing electrode 110, the sensed first capacitance C1 is larger. In contrast, as a distance between the object and the sensing electrode 110 is larger, the sensed first capacitance C1 is smaller. Therefore, the sensing and processing unit 120 can determine a distance relation of the object and the sensing electrode 110 according to the sensed first capacitance C1. Because an attached position of the sensing electrode 110 in the communication device 100 is fixed, then the sensing and processing unit 120 can determine a relative position of the object and the communication device 100 according to the distance relation of the object and the sensing electrode 110, and generate the relative position signal.

As a result, the communication device 100 can determine the relative position of the object and the communication device 100 through the first capacitance C1 sensed by the sensing electrode 110.

The radio frequency unit 130 is configured to generate a radio frequency (RF) signal. The sensing and processing unit 120 is further configured to control one of the antenna 141 and the antenna 142 to send the radio frequency signal according to the relative position signal. The antenna 141 and the antenna 142 may be attached on different positions in the communication device 100, and therefore when one of the antennas 141 and 142 has poor performance, the other antenna is switched on to send the radio frequency signal. Therefore, when the relative position signal indicates that the relative position of the object and the communication device 100 will result in a poor signal, the sensing and processing unit 120 controls the antenna 141 or the antenna 142 on different positions to send the radio frequency signal so as to effectively solve the problem of poor signal.

In another embodiment, the sensing and processing unit 120 may be configured to change a feeding point position of one of the antenna 141 and the antenna 142 according to the relative position signal so as to solve the aforementioned problem of poor signal resulting from the relative position of the object and the communication device 100.

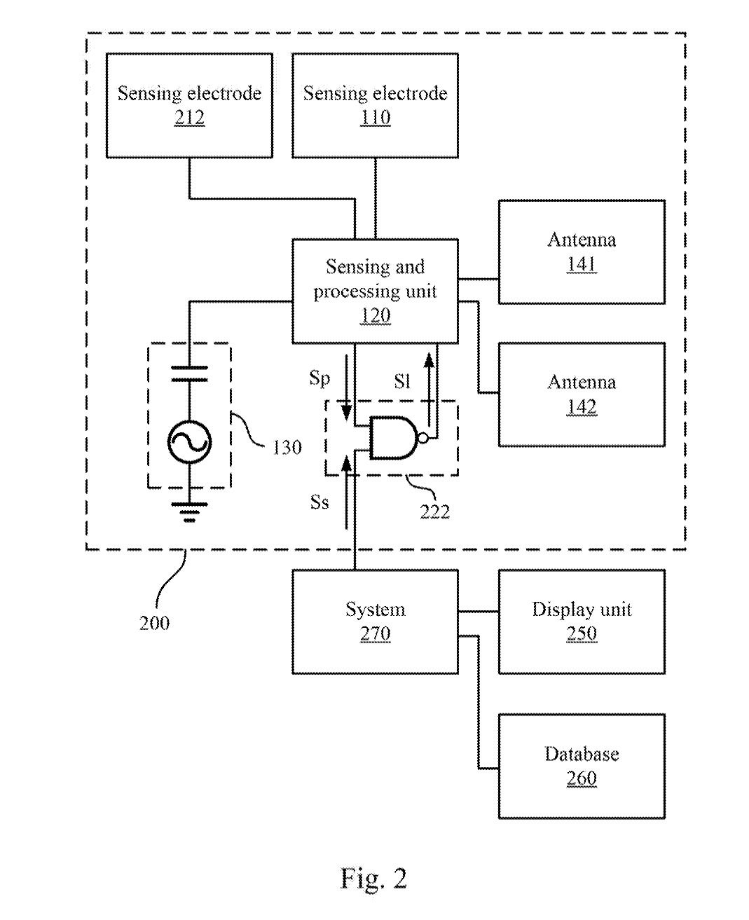

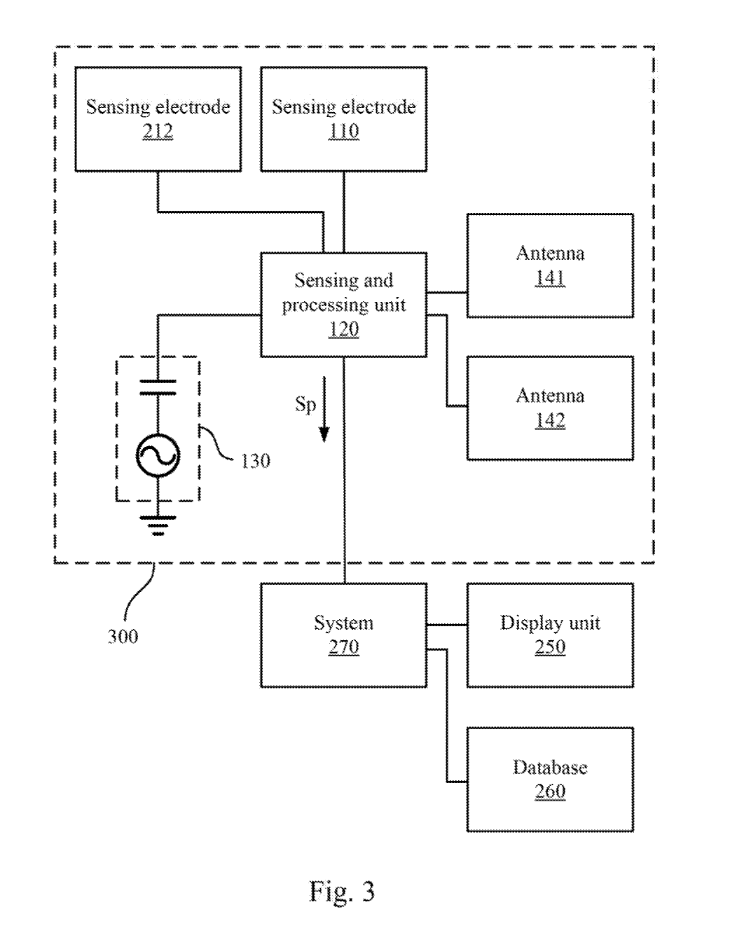

In order to further describe application of the relative position signal, references are made to FIGS. 2 and 3. FIGS. 2 and 3 are schematic diagrams of communication devices 200 and 300 according to some embodiments of the present disclosure. The communication device 200 has substantially the same configuration with the configuration of the communication device, except a sensing electrode 212 and a logic circuit 222 that are coupled to the sensing and processing unit 120.

In an embodiment, the sensing and processing unit 120 is further configured to receive a system signal Ss of a system 270. The system 270 sends the system signal Ss to the sensing and processing unit 120 to indicates that the system 270 operates in a high frequency band, a low frequency band or a particular frequency band (such as long term evolution (LTE) frequency bands B7, B17). However, the present disclosure is not limited thereto. Then, the sensing and processing unit 120 controls the antenna 141 or the antenna 142 to send the radio frequency signal generated by the radio frequency unit 130 according to the system signal Ss and the relative position signal Sp.

In a further embodiment, the logic circuit 222 is further configured to generate a logic signal Sl according to the system signal Ss and the relative position signal Sp, and the sensing and processing unit 120 controls the antenna 141 or the antenna 142 to send the radio frequency signal according to the logic signal Sl. It should be noted that the logic circuit 222 and the sensing and processing unit 120 may be independently attached in the communication device 200, or the logic circuit 222 may be integrated in the sensing and processing unit 120. However, the present disclosure is not limited thereto. In other words, in a situation where the logic circuit 222 is integrated in the sensing and processing unit 120, the sensing and processing unit 120 is further configured to generate the logic signal Sl according to the system signal Ss and the relative position signal Sp, and controls the antenna 141 or the antenna 142 to send the radio frequency signal according to the logic signal Sl.

In another embodiment, the sensing and processing unit 120 may be configured to change the feeding point position of one of the antenna 141 and the antenna 142 according to the relative position signal so as to solve the aforementioned problem of poor signal resulted from the relative position of the object and the communication device 100.

In an embodiment, the communication device 300 has substantially the same configuration with the configuration of the communication device 100, except a sensing electrode 212 that is coupled to the sensing and processing unit 120. The sensing and processing unit 120 directly controls the antenna 141 or the antenna 142 to send the radio frequency signal generated by the radio frequency unit 130 according to the relative position signal Sp.

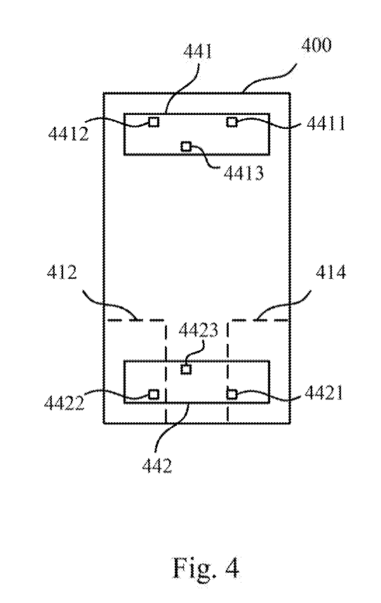

Reference is made to FIG. 4. For example, the system 270 operates in a low frequency band, and the antenna 442 has a problem of poor performance in a situation where the user holds the communication device 400 to approach the user's head by the user's left hand. In the present embodiment, the system signal Ss is 1 when the system 270 operates in a high frequency band, and the system signal Ss is 0 when the system 270 operates in the low frequency band. In a situation where the sensing electrode 110 is attached on a position 412, when the user holds the communication device 400 by a hand gesture that is closer to the sensing electrode 110 (e.g., holding the communication device 400 by the left hand) to approach the head, the sensing and processing unit 120 generates a relative position signal Sp (e.g., 0). When the user holds the communication device 400 by a hand gesture that is not closer to the sensing electrode 110 (e.g., holding the communication device 400 by the right hand) to approach the head, the sensing and processing unit 120 generate a relative position signal Sp (e.g., 1). As shown in table 1, the logic circuit 222 of the sensing and processing unit 120 generates the logic signal Sl according to the system signal Ss and the relative position signal Sp through a logic computation (e.g., a NAND computation). In an embodiment, the sensing and processing unit 120 controls the antenna 442 to send the radio frequency signal in a situation where the logic signal Sl is 0, and the sensing and processing unit 120 controls the antenna 441 to send the radio frequency signal in a situation where the logic signal Sl is 1 (i.e., the system 270 operates in the low frequency band, and the user holds the communication device 400 to approach the user's head by the left hand).

TABLE 1

| System signal Ss | Relative position signal Sp | Logic signal Sl |
|---|---|---|
| 1 (high frequency band) | 1 (right hand) | 0 |
| 1 (high frequency band) | 0 (left hand) | 0 |
| 0 (low frequency band) | 1 (right hand) | 0 |
| 0 (low frequency band) | 0 (left hand) | 1 |

As a result, the communication device 400 can effectively solve the problem of poor performance of the antenna 442 in the particular situation (e.g., the system operates in the low frequency band and the user holds the communication device 400 by the left hand to approach the head) through switching the antenna 441 to send the radio frequency signal. According to actual demand, the logic computation executed by the sensing and processing unit 120 may be another logic computation (not limited to NAND computation) to achieve an effect of switching the antennas under different conditions. The sensing electrode 110 is not limited to be attached on the position 412, and the sensing electrode 110 can also be attached on the position 414 or another position in the communication device 400 to achieve an effect of sensing another relative position. Similarly, the numbers and the positions of the antenna 441 and 442 are not limited to the numbers and the positions shown in FIG. 4.

Alternatively, in another embodiment, the sensing and processing unit 120 can be configured to change a feeding point position of one of the antenna 441 and the antenna 442 according to the relative position signal Sp and the system signal Ss to solve the so as to solve the aforementioned problem of poor signal resulted from the relative position of the object and the communication device 100. Specifically, reference is made to FIG. 4. The sensing and processing unit 120 (or the logic unit 222) can generate a logic signal (e.g., 00, 01, 10, 11) according to the relative position signal Sp and the system signal Ss, and change the feeding point position of one of the antenna 441 and the antenna 442 according to the logic signal. As shown in FIG. 4, the antenna 441 includes a ground terminal 4413 and feeding points 4411 and 4412, and the antenna 442 includes a ground terminal 4423 and feeding points 4421 and 4422. For example, the sensing and processing unit 120 may switch to the feeding point 4411 of the antenna 441 through a switch (e.g., a radio frequency switch) when the logic signal is the first logic signal (e.g., 00). Alternatively, the sensing and processing unit 120 may switch to the feeding point 4412 of the antenna 441 through the switch (e.g., the radio frequency switch) when the logic signal is the second logic signal (e.g., 01). The sensing and processing unit 120 may switch to the feeding point 4421 of the antenna 442 through the switch (e.g., the radio frequency switch) when the logic signal is the third logic signal (e.g., 10). Alternatively, the sensing and processing unit 120 may switch to the feeding point 4422 of the antenna 442 through the switch (e.g., the radio frequency switch) when the logic signal is the fourth logic signal (e.g., 11). It should be noted that the numbers and the positions of the feeding points 4411, 4412, 4421, 4422 and the ground terminals 4413, 4423 are not limited to the numbers and the positions shown in FIG. 4 according to actual demand.

As a result, the communication device 400 can have a better antenna performance through switching different antennas 441, 442 and/or different feeding points 4411, 4412, 4421 and 4422.

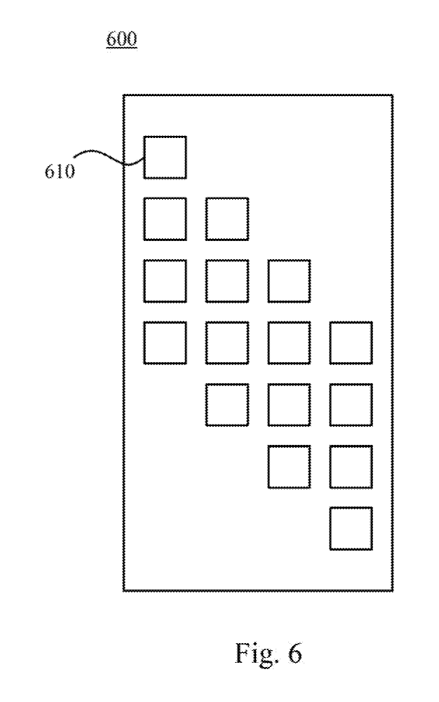

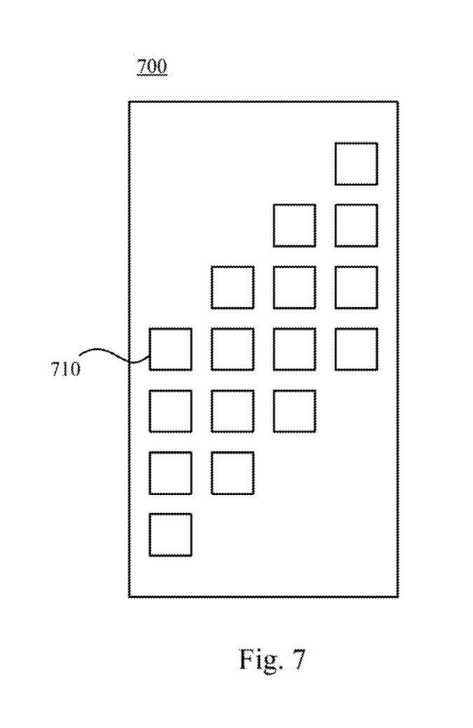

In an embodiment, because the relative position signal Sp may indicates that the user holds the communication devices 200, 300 by the left hand or the right hand and the sensing and processing unit 120 can send the relative position signal Sp to the system 270, therefore the system 270 can control the display unit 250 to display different user interfaces according to the relative position signal Sp. For example, in a situation where the user holds the communication devices 200, 300 by the left hand, the system 270 controls the display unit 250 to display a first user interface (which is shown as a user interface 600 in FIG. 6) that is convenient for left-hand operation according to the relative position signal Sp (e.g., a first position signal) so that the user can use the left hand to click an icon 610 of an application conveniently. In contrast, in a situation where the user holds the communication devices 200, 300 by the right hand, the system 270 controls the display unit 250 to display a second user interface (which is shown as a user interface 700 in FIG. 7) that is convenient for right-hand operation according to the relative position signal Sp (e.g., a second position signal) so that the user can use the right hand to click an icon 710 of an application conveniently. Compared to the prior art, the user interface 600 and the user interface 700 displayed by the display unit 250 that is controlled by the sensing and processing unit 120 according to the relative position signal Sp are more convenient for operation.

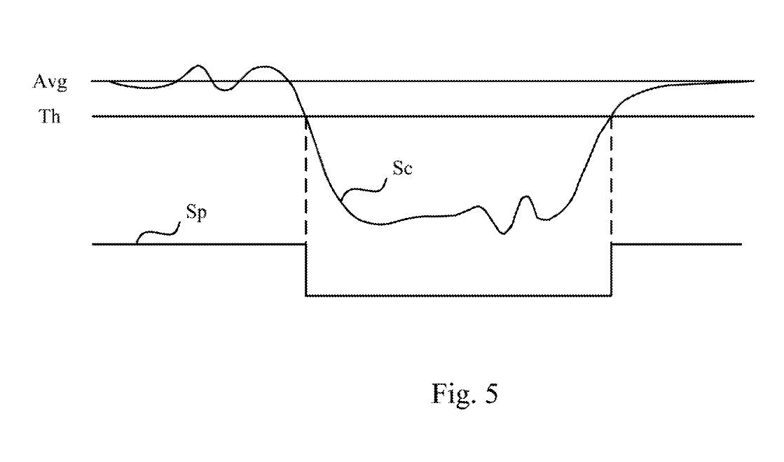

In order to describe method of generating the relative position signal Sp according to the first capacitance C1 by the sensing and processing unit 120, in an embodiment, the sensing and processing unit 120 includes a capacitive sensor. The capacitive sensor may output a count signal Sc (i.e., a count of charging and discharging by a resistor-capacitor (RC) circuit in the capacitive sensor) according to the first capacitance C1. In the present embodiment, when the first capacitance C1 increases, the count signal Sc decreases. Therefore, the sensing and processing unit 120 can reflect change of the first capacitance C1 according to change of the count signal Sc, and further reflect how much the object approaches the sensing electrode 110. For example, reference is made to FIG. 5, a curve that reflects change of the count signal Sc with time is shown in FIG. 5, in which Avg is an averaged count when no object approaches the sensing electrode 110, and Th is a threshold. When the count signal Sc is lower than the threshold Th, then the relative position signal Sp generated by a count circuit in the capacitive sensor is a first position signal (e.g., a logic low voltage level). When the count signal Sc is not lower than the threshold Th, then the relative position signal Sp generated by the count circuit is a second position signal (e.g., a logic high voltage level). The user can flexibly adjust a condition of determining the relative position of the object and the sensing electrode 110 through determining the threshold Th.

In an embodiment, the communication devices 200, 300 may include a sensing electrode 212, and the sensing electrode 212 is coupled to the sensing and processing unit 120. The sensing electrode 110 and the sensing electrode 212 may be attached to different positions in the communication device, such as the positions 412, 414 in FIG. 4. When the user's two hands approach the sensing electrode 110 and the sensing electrode 212 respectively, the sensing electrode 110 and the sensing electrode 212 sense a first capacitance C1 and a second capacitance C2 respectively. Because the sensed first capacitance C1 and the sensed second capacitance C2 of users with different physical conditions (e.g., different percentages of body fat) approach the sensing electrode 110 and the sensing electrode 212 are not completely the same, therefore the sensing and processing unit 120 is configured to send the first capacitance C1 and the second capacitance C2 to the system 270. Then, the system 270 is configured to use the first capacitance C1 and the second capacitance C2 to generate the user's physiological parameter (e.g., percentages of body fat). Specifically, the sensing and processing unit 120 can sense original capacitances C10, C20 of the sensing electrode 110 and the sensing electrode 212 before the user approach the sensing electrode 110 and the sensing electrode 212, and send the original capacitances C10, C20 to the system 270. The system 270 then calculates capacitance changes ΔC1, ΔC2 according to the first capacitance C1 and the second capacitance C2 (i.e., subtract the original capacitance C10 from the first capacitance C1, and subtract the capacitance C20 from the second capacitance C2). Then, the system 270 uses the calculated capacitance changes ΔC1, ΔC2 to search corresponding capacitance changes ΔC1, ΔC2 associated with different physical parameters (e.g., percentage of body fat) in a database, and generates a current physiological parameter of the user. In an embodiment, the system 270 may control the display unit 250 to display the physiological parameter.

In an embodiment, the sensing electrode 110 (and/or the sensing electrode 212) may be regarded as an antenna and configured to send the radio frequency signal (e.g., a high frequency band signal, a WiFi signal or a global positioning system (GPS) signal). For example, the radio frequency unit 130 (e.g., a WiFi radio frequency unit) may be coupled to the sensing electrode 110 (and/or the sensing electrode 212) to send the radio frequency (e.g., WiFi) signal (e.g., 2.4 GHz, 5 GHz bands). Alternatively, the antennas 141, 142 may send radio frequency signals of low frequency band (e.g., 850 MHz, 900 MHz bands) and/or medium frequency band (e.g., 1800 MHz, 1900 MHz bands), and the sensing electrode 110 (and/or the sensing electrode 212) may be coupled to generate radio frequency signals of other frequency bands (e.g., 2100 MHz, 2600 MHz bands). Therefore, the communication devices 100, 200 do not need an additional receiver or sensor so as to save cost and increase the area of the antenna.

In practice, the sensing and processing unit 120 may include a sensing circuit, a microprocessor, a capacitive sensor and a radio frequency switch.

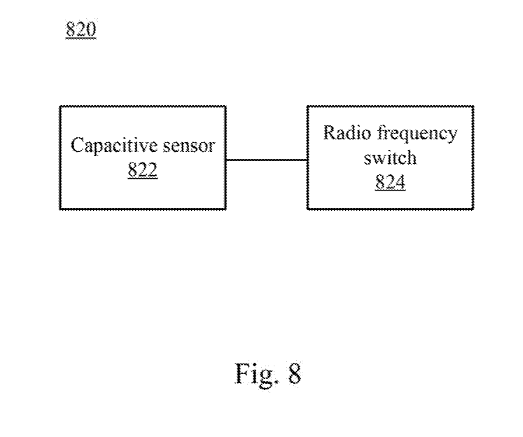

Reference is made to FIG. 8. In an embodiment, the sensing and processing unit 820 includes a capacitive sensor 822 and a radio frequency switch 824. The capacitive sensor 822 generate relative position signal Sp through the above method. The radio frequency switch 824 is configured to switch one of the first antenna 141 and the second antenna 142 to send the radio frequency signal according to the relative position signal Sp. Alternatively, in another embodiment, the radio frequency switch 824 is configured to switch one of the first antenna 141 and the second antenna 142 to send the radio frequency signal according to the relative position signal Sp and the system signal Ss.

As a result, the communication device of the present disclosure can determine the relative position of the object and the communication device through the sensing electrode, improve the antenna performance and display the user interface that is convenient for operation according to the relative position. Moreover, the present disclosure can also measure the current physical parameter of the user.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A communication device, comprising:
a first sensing electrode, configured to sense a first capacitance when an object approaches the communication device;
a sensing and processing unit, configured to generate a relative position signal of the object and the communication device according to the first capacitance;
a radio frequency unit, coupled to the sensing and processing unit and configured to generate a radio frequency signal;
a first antenna, coupled to the sensing and processing unit; and
a second antenna, coupled to the sensing and processing unit;
wherein the sensing and processing unit is further configured to control one of the first antenna and the second antenna to send the radio frequency signal according to the relative position signal.

2. The communication device of claim 1, wherein the sensing and processing unit is further configured to change a feeding point position of the one of the first antenna and the second antenna according to the relative position signal.

3. The communication device of claim 1, wherein the sensing and processing unit is further configured to receive a system signal, and control the one of the first antenna and the second antenna to send the radio frequency signal according to the system signal and the relative position signal.

4. The communication device of claim 3, wherein the sensing and processing unit is further configured to change a feeding point position of the one of the first antenna and the second antenna according to the system signal and the relative position signal.

5. The communication device of claim 3, wherein the sensing and processing unit is further configured to generate a logic signal according to the system signal and the relative position signal, and control the one of the first antenna and the second antenna to send the radio frequency signal according to the logic signal.

6. The communication device of claim 5, wherein the sensing and processing unit is further configured to change a feeding point position of the first antenna and the second antenna according to the logic signal.

7. The communication device of claim 3, wherein the system signal indicates that a system connected to the communication device operates in a high frequency band, a low frequency band or a particular frequency band.

8. The communication device of claim 1, wherein the relative position signal comprises a first position signal and a second position signal, and the sensing and processing unit comprises:
a capacitive sensor, configured to generate a count signal according to the first capacitance, generate the first position signal in a situation where the count signal is lower than a threshold, and generate the second position signal in a situation where the count signal is not lower than the threshold; and
a radio frequency switch, configured to switch the one of the first antenna and the second antenna to send the radio frequency signal according to the relative position signal.

9. The communication device of claim 1, wherein the sensing and processing unit is further configured to send the relative position signal to a system, and the system is configured to control a display unit to display a first user interface or a second user interface according to the relative position signal.

10. The communication device of claim 1, further comprising:
a second sensing electrode, coupled to the sensing and processing unit and configured to sense a second capacitance when an object approaches the communication device.

11. The communication device of claim 1, wherein the sensing and processing unit is further configured to send the first capacitance and the second capacitance to a system, and the system is configured to use the first capacitance and the second capacitance to search a database to generate a physiological parameter.

12. The communication device of claim 1, wherein the first sensing electrode is further configured to send the radio frequency signal.
